(19) United States
(12) Patent Application Publication
(10) Pub. No.: US 2024/0217388 A1
(43) Pub. Date: Jul. 4, 2024

(54) PROBABILISTIC MODELLING OF ELECTRIC VEHICLE CHARGING AND DRIVING USAGE BEHAVIOR WITH HIDDEN MARKOV MODEL-BASED CLUSTERING

(71) Applicant: Volkswagen Aktiengesellschaft, Wolfsburg (DE)

(72) Inventors: Gianina Alina Negoita, San Leandro, CA (US); Matthew Yen, Bellaire, TX (US); William Paxton, Redwood City, CA (US)

(21) Appl. No.: 18/091,281

(22) Filed: Dec. 29, 2022

(51) Int. Cl. B60L 58/16; G06F 18/2413

(52) U.S. Cl. CPC B60L 58/16; G06F 18/2413; B60L 2240/54

(57) ABSTRACT

Technologies and techniques for processing a state of health for a battery in a battery management system. One or more data features may be extracted from a multivariate time series data associated with a plurality of vehicles, the multivariate time series data including battery information data for the vehicles. The one or more extracted data features are processed to represent the one or more extracted data features as a plurality of models comprising a series of outputs generated by one of several internal states. The processed extracted data features are clustered to group the data features into a plurality of first groups, based on a similarity metric. The plurality of first groups are then clustered to generate a second group, and a state of health indication may be determined for the battery information based on the second group.

### TECHNICAL FIELD

The present disclosure relates to methods, apparatuses, and systems for a battery management system (BMS) and, more particularly, to a BMS that uses Hidden Markov Model-based clustering for battery usage behavior generation.

### BACKGROUND

Electric vehicles (EV) and electric cars are becoming a more viable option for many drivers. During use, EV batteries will slowly lose capacity over time, with current EVs averaging around 2% of range loss per year. Over many years, the driving range may be noticeably reduced. EV batteries can be serviced and individual cells inside the battery can be replaced if they go bad. However, there's the risk after many years of service and several hundred thousand miles that the entire battery pack may need to be replaced if it has degraded too much. Often times, charging and driving usage behavior by drivers will affect how quickly or slowly an EV battery may degrade.

Many advanced battery operations require assumptions about how a battery will be used. For EVs, battery usage is determined by the behavioral characteristics of the driver(s) and the availability of charging facilities. However, understanding patterns in human behavior, particularly for EV usage is very difficult, especially as it is represented in multivariate time series signals. Determining similarities between multivariate time series is a challenging task.

### SUMMARY

Various apparatus, systems and methods are disclosed herein relating to controlling operation of a vehicle. In some illustrative embodiments, a battery management system is disclosed for processing a state of health for a battery, comprising: at least one data storage configured to store computer program instructions; and at least one processor, operatively coupled to the at least one data storage, wherein the at least one processor is configured to: extract one or more data features from a multivariate time series data associated with a plurality of vehicles, the multivariate time series data comprising battery information data for the vehicles; process one or more extracted data features to represent the one or more extracted data features as a plurality of models comprising a series of outputs generated by one of several internal states; cluster the processed extracted data features to group the data features into a plurality of first groups, based on a similarity metric; cluster the plurality of first groups to generate a second group; and determine a state of health indication for the battery information based on the second group.

In some examples, a computer-implemented method of processing a state of health for a battery in a battery management system is disclosed, comprising: extracting one or more data features from a multivariate time series data associated with a plurality of vehicles, the multivariate time series data comprising battery information data for the vehicles; processing one or more extracted data features to represent the one or more extracted data features as a plurality of models comprising a series of outputs generated by one of several internal states; clustering the processed extracted data features to group the data features into a plurality of first groups, based on a similarity metric; clustering the plurality of first groups to generate a second group; and determining a state of health indication for the battery information based on the second group.

In some examples, a non-transitory computer-readable medium is disclosed, storing executable instructions for processing a state of health for a battery for a battery management system, when executed by one or more processors, causes one or more processors to: extract one or more data features from a multivariate time series data associated with a plurality of vehicles, the multivariate time series data comprising battery information data for the vehicles; process one or more extracted data features to represent the one or more extracted data features as a plurality of models comprising a series of outputs generated by one of several internal states; cluster the processed extracted data features to group the data features into a plurality of first groups, based on a similarity metric; cluster the plurality of first groups to generate a second group; and determine a state of health indication for the battery information based on the second group.

### BRIEF DESCRIPTION OF THE FIGURES

The present invention is illustrated by way of example and not limitation in the figures of the accompanying drawings, in which like references indicate similar elements and in which:

FIG. 1 shows an exemplary vehicle system block diagram showing multiple components and modules according to some aspects of the present disclosure;

FIG. 2 shows an exemplary network environment illustrating communications between a vehicle and a server/cloud network according to some aspects of the present disclosure;

FIG. 3A shows an exemplary block diagram flowchart for an artificial intelligence (AI) pipeline according to some aspects of the present disclosure;

FIG. 3B shows a continuation of the exemplary block diagram flowchart for the AI pipeline of FIG. 3A according to some aspects of the present disclosure;

FIG. 4A shows a simulated chart of time-series data obtained from an AI pipeline according to some aspects of the present disclosure;

FIG. 4B shows a simulated chart of a linear interpolation of the resampled time-series data of FIG. 4A according to some aspects of the present disclosure;

FIG. 5A shows a simulated chart showing vehicle and battery data according to some aspects of the present disclosure;

FIG. 5B shows a simulated chart showing engineered features extracted from the vehicle and battery data of FIG. 5A according to some aspects of the present disclosure;

FIG. 6 shows an example of a process for clustering EV usage using Hidden Markov Models according to some aspects of the present disclosure;

FIG. 7 shows an exemplary diagram of hidden state sequences of raw multivariate time series according to some aspects of the present disclosure; and

FIG. 8 shows a flowchart illustrating a process for processing a state of health for a battery under some aspects of the present disclosure.

### DETAILED DESCRIPTION

The figures and descriptions provided herein may have been simplified to illustrate aspects that are relevant for a clear understanding of the herein described devices, structures, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

Exemplary embodiments are provided throughout so that this disclosure is sufficiently thorough and fully conveys the scope of the disclosed embodiments to those who are skilled in the art. Numerous specific details are set forth, such as examples of specific components, devices, and methods, to provide this thorough understanding of embodiments of the present disclosure. Nevertheless, it will be apparent to those skilled in the art that specific disclosed details need not be employed, and that exemplary embodiments may be embodied in different forms. As such, the exemplary embodiments should not be construed to limit the scope of the disclosure. In some exemplary embodiments, well-known processes, well-known device structures, and well-known technologies may not be described in detail.

The terminology used herein is for the purpose of describing particular exemplary embodiments only and is not intended to be limiting. As used herein, the singular forms “a”, “an” and “the” may be intended to include the plural forms as well, unless the context clearly indicates otherwise. The terms “comprises,” “comprising.” “including,” and “having.” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the exemplary embodiments.

The disclosed embodiments may be implemented, in some cases, in hardware, firmware, software, or any tangibly-embodied combination thereof. The disclosed embodiments may also be implemented as instructions carried by or stored on one or more non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

It will be understood that the term “module” as used herein does not limit the functionality to particular physical modules, but may include any number of tangibly-embodied software and/or hardware components. In general, a computer program product in accordance with one embodiment comprises a tangible computer usable medium (e.g., standard RAM, an optical disc, a USB drive, or the like) having computer-readable program code embodied therein, wherein the computer-readable program code is adapted to be executed by a processor (working in connection with an operating system) to implement one or more functions and methods as described below. In this regard, the program code may be implemented in any desired language, and may be implemented as machine code, assembly code, byte code, interpretable source code or the like (e.g., via Scalable Language (“Scala”), C, C++, C#, Java, Actionscript, Objective-C. Javascript, CSS, XML, etc.).

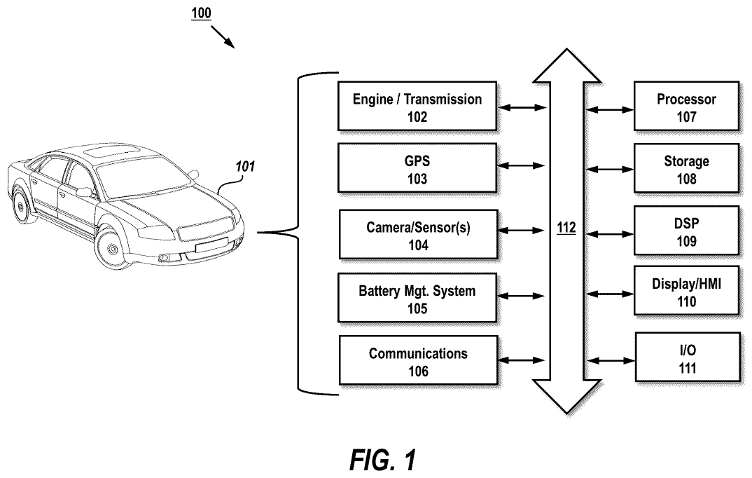

Turning to FIG. 1, the drawing illustrates an exemplary system 100 for a vehicle 101 comprising various vehicle electronics circuitries, subsystems and/or components. Engine/transmission circuitry 102 is configured to process and provide vehicle engine and transmission characteristic or parameter data, and may comprise an engine control unit (ECU), and a transmission control. For electric vehicles, the ECU may be configured as an electric drive controller (EDC) that works in conjunction with battery management system (BMS) 105. In some examples, the BMS monitors the various characteristics of vehicle power, including battery temperature, battery voltage, battery current, and battery charging and discharging data. This information can be stored locally by the BMS 105 and/or the processor 107. The BMS 105 can also transmit such monitored information via the vehicle communications circuitry 106 to an external storage device (e.g., in the cloud). The BMS 105 may regulate the operating conditions of the vehicle power/battery, and perform functions such as regulating the battery temperature to within a predefined threshold temperature.

Global positioning system (GPS) circuitry 103 provides navigation processing and location data for the vehicle 101. The camera/sensors 104 provide image or video data (with or without sound), and sensor data which may comprise data relating to vehicle characteristic and/or parameter data (e.g., from 102), and may also provide environmental data pertaining to the vehicle, its interior and/or surroundings, such as temperature, humidity and the like, and may further include LiDAR, radar, image processing, computer vision and other data relating to manual, semi-autonomous and/or autonomous (or “automated”) driving and/or assisted driving.

Communications circuitry 106 allows any of the circuitries of system 100 to communicate with each other and/or external devices (e.g., devices 202-203) via a wired connection (e.g., Controller Area Network (CAN bus), local interconnect network, etc.) or wireless protocol, such as 3G, 4G, 5G, Wi-Fi, Bluetooth, Dedicated Short Range Communications (DSRC), cellular vehicle-to-everything (C-V2X) PC5 or NR, and/or any other suitable wireless protocol. While communications circuitry 106 is shown as a single circuit, it should be understood by a person of ordinary skill in the art that communications circuitry 106 may be configured as a plurality of circuits. In one embodiment, circuitries 102-106 may be communicatively coupled to bus 112 for certain communication and data exchange purposes.

Vehicle 101 may further comprise a main processor 107 (also referred to herein as a “processing apparatus”) that centrally processes and controls data communication throughout the system 100. The processor 107 may be configured as a single processor, multiple processors, or part of a processor system. In some illustrative embodiments, the processor 107 is equipped with autonomous driving and/or advanced driver assistance circuitries and infotainment circuitries that allow for communication with and control of any of the circuitries in vehicle 100. Storage 108 may be configured to store data, software, media, files and the like, and may include sensor data, machine-learning data, fusion data and other associated data, discussed in greater detail below. Digital signal processor (DSP) 109 may comprise a processor separate from main processor 107, or may be integrated within processor 107. Generally speaking, DSP 109 may be configured to take signals, such as voice, audio, video, temperature, pressure, sensor, position, etc. that have been digitized and then process them as needed. Display 110 may consist of multiple physical displays (e.g., virtual cluster instruments, infotainment or climate control displays). Display 110 may be configured to provide visual (as well as audio) indicial from any circuitry in FIG. 1, and may be a configured as a human-machine interface (HMI), LCD, LED, OLED, or any other suitable display. The display 110 may also be configured with audio speakers for providing audio output. Input/output circuitry 111 is configured to provide data input and outputs to/from other peripheral devices, such as cell phones, key fobs, device controllers and the like. As discussed above, circuitries 102-111 may be communicatively coupled to data bus 112 for transmitting/receiving data and information from other circuitries.

In some examples, when vehicle 101 is configured as an autonomous vehicle, the vehicle may be navigated utilizing any level of autonomy (e.g., Level 0-Level 5). The vehicle may then rely on sensors (e.g., 104), actuators, algorithms, machine learning systems, and processors to execute software for vehicle navigation. The vehicle 101 may create and maintain a map of their surroundings based on a variety of sensors situated in different parts of the vehicle. Radar sensors may monitor the position of nearby vehicles, while video cameras may detect traffic lights, read road signs, track other vehicles, and look for pedestrians. LiDAR sensors may be configured bounce pulses of light off the car's surroundings to measure distances, detect road edges, and identify lane markings. Ultrasonic sensors in the wheels may be configured to detect curbs and other vehicles when parking. The software (e.g., stored in storage 108) may processes all the sensory input, plot a path, and send instructions to the car's actuators, which control acceleration, braking, and steering. Hard-coded rules, obstacle avoidance algorithms, predictive modeling, and object recognition may be configured to help the software follow traffic rules and navigate obstacles.

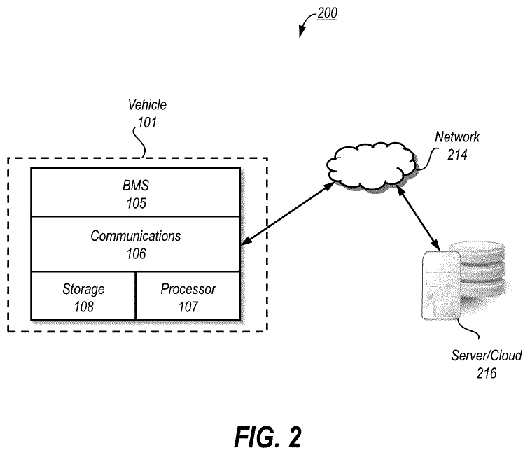

Turning to FIG. 2, the figure shows an exemplary network environment 200 illustrating communications between a vehicle 101 and a server/cloud network 214 according to some aspects of the present disclosure. In this example, the vehicle 101 of FIG. 1 is shown with storage 108, processing apparatus 107 and communications circuitry 106 that is configured to communicate via a network 214 to a server or cloud system 214. It should be understood by those skilled in the art that the server/could network 214 may be configured as a single server, multiple servers, and/or a computer network that exists within or is part of a cloud computing infrastructure that provides network interconnectivity between cloud based or cloud enabled application, services and solutions. A cloud network can be cloud based network or cloud enabled network. Other networking hardware configurations and/or applications known in the art may be used and are contemplated in the present disclosure.

In some examples, the battery management system (BMS) 210 of vehicle is configured to manage the electronics of a rechargeable battery, whether a cell or a battery pack, to ensure that the cell operates within its safe operating parameters. The BMS 105 monitors the State Of Health (SOH) of the battery, collects data, controls environmental factors that affect the cell, and balances them to ensure the same voltage across cells. The BMS 105 is communicatively coupled to communications 106 for transmitting and receiving data, including fuel gauge integration, smart bus communication protocols, General Purpose Input Output (GPIO) options, cell balancing, wireless charging, embedded battery chargers, and protection circuitry, and other data associated with the battery's power status. The BMS 105 may also be configured to manage its own charging, generate error reports, detect and notify the device of any low-charge condition, and predict how long the battery will last or its remaining run-time. The BMS 105 also provides information about the current, voltage, and temperature of the cell and continuously self-corrects any errors to maintain its prediction accuracy.

Generally, the BMS 105 is configured to perform numerous functions including monitoring battery parameters to determine the state of a cell. The cell state may be represented by such parameters as voltage, indicating a cell's total voltage, the battery's combined voltage, maximum and minimum cell voltages, and so on. Other parameters include temperature, to determine an average cell temperature, coolant intake and output temperatures, and the overall battery temperature, the state of charge of the cell to show the battery's charge level, and the cell's state of health (SOH), indicating the remaining battery capacity as a percentage of the original capacity. Further parameters may include the cell's state of power, showing the amount of power available for a certain duration given the current usage, temperature, and other factors, the cell's state of safety, determined by monitoring all the parameters and determining if using the cell poses any danger, the flow of coolant and its speed, and the flow of current into and out of the cell.

Another function of the BMS 105 includes managing thermal temperatures. A battery's thermal management system monitors and controls the temperature of the battery. These systems can either be passive or active, and the cooling medium can either be a non-corrosive liquid, air, or some form of phase change. The BMS 105 may further calculate various battery values, based on parameters such as maximum charge and discharge current to determine the cell's charge and the discharge current limits. These parameters include the energy in kilowatt-hour(s) (kWh) delivered since the last charge cycle, the internal impedance of a battery to measure the cell's open-circuit voltage, charge in Ampere per hour (Ah) delivered or contained in a cell (also known as the Coulomb counter) to determine the cell's efficiency, total energy delivered and operating time since the battery started being used, and total number of charging-discharging cycles the battery has gone through.

The BMS 105 may also include controllers that communicate internally with the hardware at a cellular level and externally with connected devices, including network 214 and server/cloud 216. The external communications may be configured through a centralized controller, and it can be communicated using several methods, including different types of serial communications, CAN bus communicators, DC-BUS communications, and/or various types of wireless communication including radio, pagers, cellphones, etc.

In some examples, the BMS 105 operates independently and/or in conjunction with other vehicle 101 components (e.g., 102, 106, 107, 108, 109) to make determinations on how a battery will be used. The battery usage may be determined by the behavioral characteristics of the driver(s) and the availability of charging facilities. In some examples, patterns in driver behavior may be analyzed as a representation of multivariate time series signals. Using cluster identification, objects may be partitioned into homogenous clusters, where objects within a cluster are classified as similar and objects in different clusters are classified as dissimilar. Once the underlying patterns are determined, usage behavior is classified and can be made predictable.

As will be explained in greater detail below, clustering from time series data may include a pipeline of data manipulation steps, including, but not limited to, interpolation, sampling adjustments, feature engineering, and a mathematical representation of the data to determine quantitative similarity. If adequate features are extracted from input data, desired cluster borders may be determined to separable clusters. The extracted features should be selected and configured to avoid undesired cluster borders and mixing of overlapping features in one cluster. The present disclosure improves cluster identification for battery usage data by detecting underlying patterns and also aims at generating battery usage synthetic data. Real-world driving and charging data for EVs is limited and it takes a very long time to process. Generating battery usage synthetic data is advantageous to improve models by training on more data when combining real-world data with synthetic data and/or to further validate models.

In some examples, a hybrid time series clustering algorithm is used with clustering techniques, induced with a probabilistic model, such as Hidden Markov Model (HMM). The HMM may be configured to process data that can be represented as sequence of observations over time. The HMM may be configured as a probabilistic framework where the observed data is modeled as a series of outputs generated by one of several, hidden, internal states. Each vehicle may be identified with a vehicle identification number (VIN) and represented by a HMM, where clustering is performed, and each cluster is represented by a HMM. The clustering and HMM complement each other and provide better clustering performance than when not using HMM. Vehicle features may be extracted, based on induced domain knowledge, in order to further improve algorithm performance.

The clustering algorithms are used to group time series data based on a similarity/distance metric (measure). In cases when it is desired to eliminate the use of a distance measure, HMMs are used to cluster time series. To obtain more improved clustering results with HMMs, it is advantageous to start a HMM clustering algorithm with an approximate initial clustering provided by an initial clustering algorithm. Since standard clustering algorithms can provide good initial partition, the HMM clustering algorithm may be initialized with it. An assumption in clustering using HMMs is that all the sequences that belong to a specific cluster were generated by the same HMM and, as such, have high probabilities under that HMM. Due to this assumption, the task of clustering time series is equivalent with the task of finding a set of HMMs that accept disjointed subsets of the original set of time series.

Time series can be clustered by initially fitting an HMM to all the data and then applying a fixed-point operation that refines the HMM and “shrinks” the initial set to the subset of time series accepted by the resulting HMM. Clustering may be configured to repeat the fixed-point operation for the remaining time series until there are no more time series left unassigned. In some examples, each EV may be configured as a stochastic system that occupies and transitions between hidden states. Thus, each hidden state is indicative of a different type of driving or charging behavior. The probabilistic model allows the system (200) to characterize each EV through probability distributions and obtain a kind of embedding for each VIN, followed by performing clustering processes as described herein. Furthermore, combining the domain knowledge induced features with clustering via HMMs yields better clustering performance.

Such an approach allows a user to determine the similarity between time series of any lengths. Conventional distance-based clustering, i.e., determining how similar two sequences are, relies on a distance metric that calculates the distances between data points of two time series. Typical measures that rely on Euclidean matching require that two time series are of equal length, which is highly unlikely in real-world use, given that vehicles are operated independently of one another. Another typical measurement is dynamic time warping (DTW), which does not take into account the distribution of feature values, which may be a drawback in characterizing battery usage. Another advantage of the present disclosure is that the system does not require two time series to be in phase with one another, or have the same periodicity. Furthermore, from each identified cluster, data can be generated by the HMM for that particular cluster, which is much easier to obtain than collecting real world driving and charging.

As such, technologies and techniques of the present disclosure can be implemented for identifying clusters of similar EV charging and driving behaviors. Clustering can be particularly useful for a targeted time series data preprocessing pipeline. Once the preprocessing is complete, a user can train multiple forecast models for different clusters of the time series data, or can include the clustering configuration as metadata for the overall time series analysis. This can be done to improve state of health (SOH) prediction models for EVs using easily accessible and simple pack level data. Moreover, the HMM trained for each cluster can be used to generate battery usage synthetic data. In some examples, synthetic data may be used to improve the models and/or as a test dataset for cluster validation. For example, this approach may be useful in cases when a system produces multivariate time series data, and one of a plurality of HMM models are selected (e.g., fitting a HMM model to each cluster), generating data according to that model, and periodically transitioning to a different HMM.

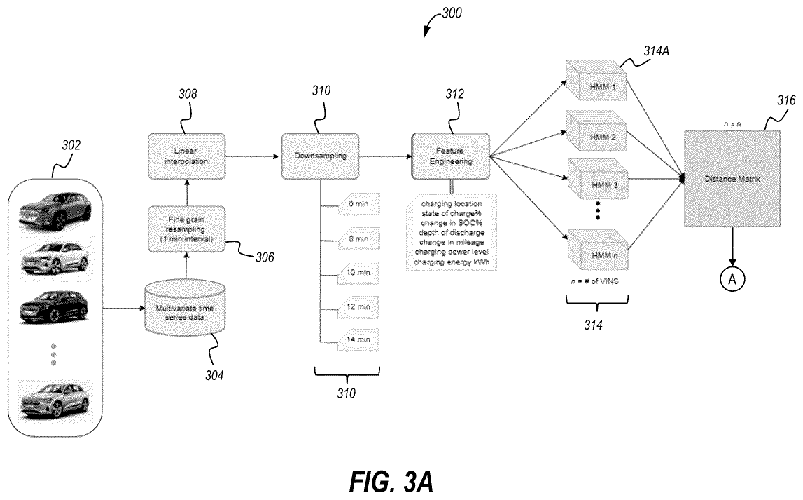

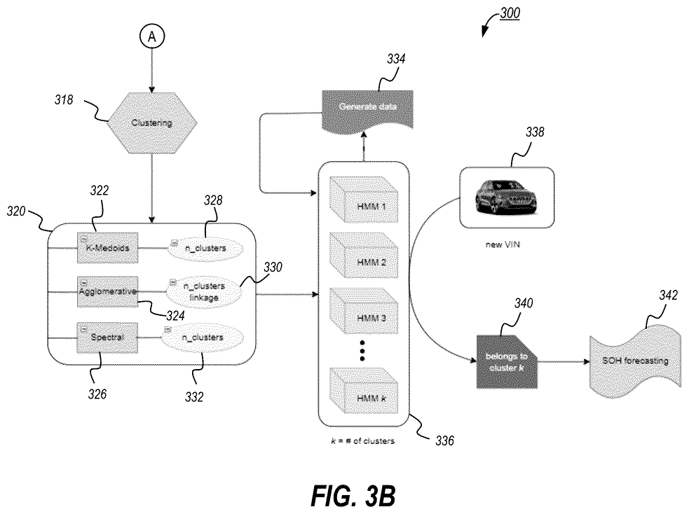

FIG. 3A shows an exemplary block diagram flowchart for an artificial intelligence (AI) pipeline 300 according to some aspects of the present disclosure. In some examples, the AI pipeline 300 is configured to set up a hybrid time series clustering algorithm pipeline that uses a probabilistic model, Hidden Markov Model (HMM) induction, combined with clustering techniques. In the example of FIG. 3A, vehicle data from vehicles 302, each of which may be configured similarly to vehicle 101, are collected and stored as multivariate time series data in storage 304. The multivariate time series data for each vehicle of 302 may be expressed as a vehicle identification number (VIN), where each VIN includes a plurality of time-dependent variables, and each variable depends not only on its past values but also has some dependency on other variables. In a simplified example, for n time series variables {y₁ₜ}, {y₂ₜ} . . . , {yₙₜ} for a vehicle (302), a multivariate time series may be the (n×1) vector time series {Yₜ} where the i^{th} row of {Yₜ} is {yᵢₜ}. That is, for any time t, Yₜ=(y₁ₜ, y₂ₜ . . . , yₙₜ). The multivariate time series data is then resampled (e.g., upsampled) in block 306 to modify the frequency of the time series observations. In some examples, the fine grain resampling interval of the multivariate time series data in block 306 may be selected to be short enough to reflect a robust data set for processing (e.g., 1 minute), without over-sampling or under-sampling. In time series, resampling ensures that the data is distributed with a consistent frequency. Resampling can also provide a different perception of looking at the data, in other words, it can add additional insights about the data based on the resampling frequency or interval.

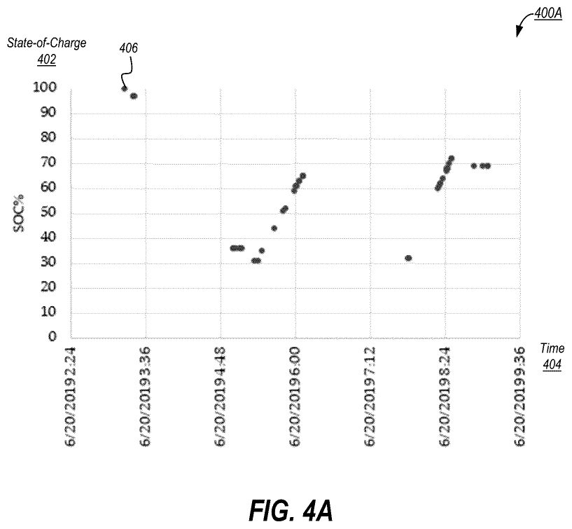

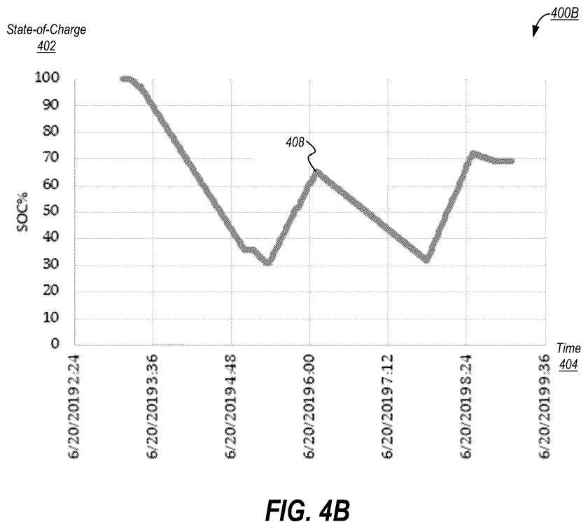

In block 308, interpolation is performed on the resampled data to fill in any missing values as a result of the resampling in block 306. In some examples, linear interpolation is used in block 308 by applying a process of curve fitting using linear polynomials to construct new data points within the range of a discrete set of known data points. FIGS. 4A-4B illustrate an output of an illustrative linear interpolation process. FIG. 4A shows a simulated chart 400A of time-series data obtained from an AI pipeline (e.g., 300) according to some aspects of the present disclosure. In this example, a plurality of individual time series data points 406 are illustrated, showing a battery SOC percentage (%) 404 over a time scale 404.

FIG. 4B shows a simulated chart 400B of a linear interpolation output of the resampled time-series data of FIG. 4A according to some aspects of the present disclosure. Here, the individual time series data points 406 are subjected to linear interpolation, wherein the process searches for lines that passes through end points of each of the time series data points 406, resulting in the representation 408 as shown in the figure. As can be seen, the linear interpolation imposes regularity to the time series data for further processing in the AI pipeline, and processing missing values assists in the interpretation of time series profiles and model learning. The amount of time (time scale) between measurements may be adjusted to affect the interpretation of rates of change and time spent at a value, both of which are important for accurately modeling driving and charging behavior.

Turning back to FIG. 3A, once linear interpolation is performed in block 308, the interpolated time series data may then be down sampled in block 310 to compress the data to one or more configured time periods 310. In this example, the down sampling may be performed on any of the shown 6-, 8-, 10-, 12- and 14-minute time scales. Of course, other time periods may be used, depending on the application. After down sampling, the data is subjected to feature engineering in block 312. Generally, feature engineering refers to the process of using domain knowledge to select and transform the most relevant variables from raw data when creating a predictive model using machine learning or statistical modeling. The feature engineering of block 312 performs preprocessing steps that transform the raw data into features that can be used in machine learning algorithms, such as predictive models (314, 318, 320, 336).

The feature engineering of block 312 may be configured to perform creation, transformation, extraction, and selection of features (also known as variables), that are most conducive to creating accurate algorithms. Feature creation may involve identifying the variables that will be most useful in the predictive model. In some examples, existing features may be mixed via addition, subtraction, multiplication, and ratio to create new derived features that have additional predictive power. In the example of FIG. 3A, some features of interest may include, but are not limited to, charging location for a vehicle, state of charge %, change in SOC %, depth of discharge, change in mileage, charging power level, and/or charging energy (kWh). Transformation may be performed in block 312 to manipulate predictor variables to improve model performance (e.g., ensuring the model is flexible in the variety of data it can ingest), ensure variables are on the same scale, make the model easier to understand, improve accuracy, and avoid computational errors by ensuring all features are within an acceptable range for the model.

Feature engineering of block 312 may also be configured to preprocess the data for feature extraction which creates variables by extracting them from raw data. The purpose of feature extraction is to automatically reduce the volume of data into a more manageable set for modeling (e.g., cluster analysis, principal components analysis, etc.). Other pre-processing steps may include data augmentation, cleaning, delivery, fusion, ingestion, and/or loading. Feature selection may also be configured to analyze, judge, and rank various features to determine which features are irrelevant and should be removed, which features are redundant and should be removed, and which features are most useful for the model and should be prioritized.

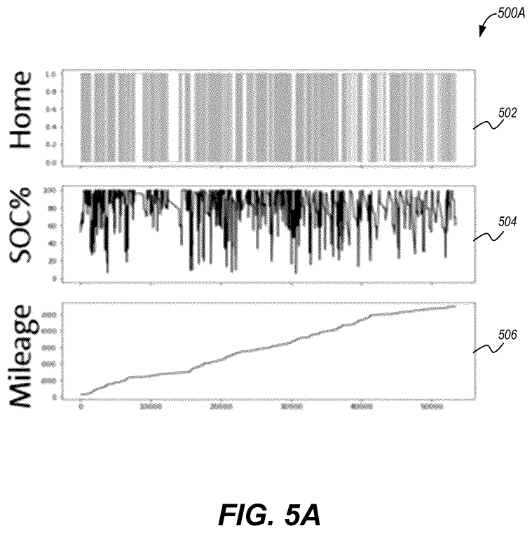

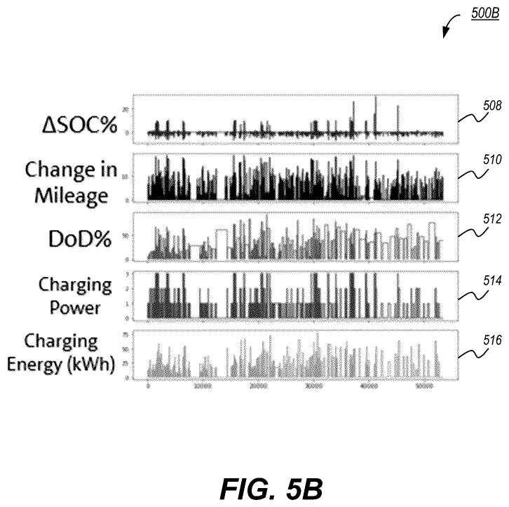

FIGS. 5A and 5B illustrate an example of feature extractions. FIG. 5A shows a simulated chart showing vehicle and battery data, and FIG. 5B shows a simulated chart showing engineered features extracted from the vehicle and battery data of FIG. 5A according to some aspects of the present disclosure. Here, one engineered feature includes charging location 502, which is depicted as a binary data set indicating if a driver charged from home (1=yes) or not (0=no). Another engineered feature includes SOC % 504 which determines a percentage of available battery capacity. This feature may be used to calculate a change in SOC % 508, and may be calculated by the difference in subsequent measurements of SOC. This value is configured to captures rates of change 508 as a feature and helps to characterize both charge and discharge rates, with higher values indicating higher current loads, which in turn indicate an accelerated degradation of a battery.

Another engineered feature may be a feature associated with a change in mileage 510, which may be calculated by the difference among subsequent measurements of vehicle mileage 506, indicating the number of miles travelled during a configured timestep. A further engineered feature may include depth of discharge (DoD) 512 percentage, calculated from the total change in SOC (504) during a discharge cycle. In some examples, greater magnitudes of DoD indicate faster active mass loss and ageing in the battery. Charging energy features 516 may be derived to indicate charging power levels (e.g., slow, fast, rapid; charging levels 0-3, etc.) that reflect the maximum charging rate used during a charging session. Higher levels can lead to unwanted chemical reactions that cause irreversible capacity loss in the battery. In some examples, the charging energy may be determined as energy input in kWh per cycle, since batteries continue to age with accumulated energy throughput.

Returning to FIG. 3A, the engineered features are then subjected to fitted modeling 314, where a model (314A) is fitted for each vehicle (HMM 1-HMM n). In this example, a Hidden Markov Model is used, although one of ordinary skill in the art will appreciate, other suitable models may be used as well. The models for each vehicle in 314 may then be processed to form a n×n distance metric, where n represents the number of VINs in the dataset, for clustering (FIG. 3B, 318). Under some aspects of the present disclosure, a hybrid time series clustering algorithm is utilized, using clustering (318), combined with a probabilistic model, such as HMM induction.

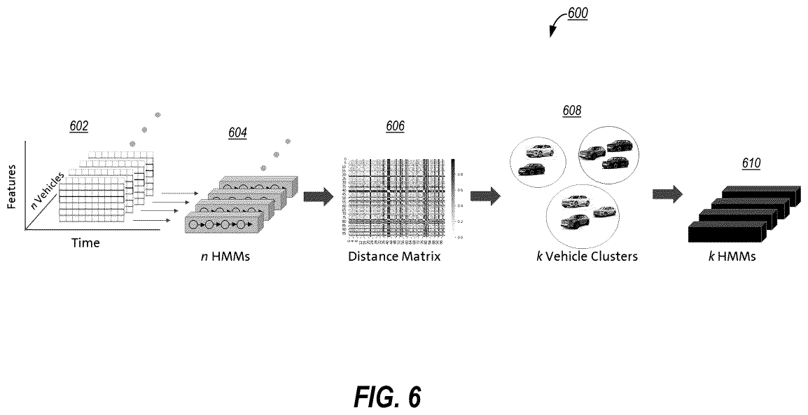

An example of an HMM-based clustering process 600 is shown in FIG. 6, after feature engineering, where each vehicle n is represented by a multivariate time series of an arbitrary length in time 602. Each time series is then used to train a respective m-state HMM 604. Once each model is fitted, the distance between all pairs of models is computed using mutual fitness to construct a distance matrix 606. The distance matrix is used as input for the clustering algorithm (320) to produce k vehicle clusters 608 representing vehicles (which may be different vehicles) sharing the same cluster characteristics. Each of the vehicle clusters 608 may then be processed to produce respective k HMMs 610, as explained further below.

In general, clustering can be classified into two broad categories: model-based and similarity-based. For similarity-based techniques, the main task is to define pairwise distances between all the sequences and then apply distance-based clustering algorithms. For example, correlation coefficients may be adopted to define similarities among data characteristics from different time course measurements. Agglomerative hierarchical clustering may then be applied to find clusters of data with similar patterns of characteristics. Similarly, Dynamic Time Warping (DTW) may be used to measure the similarities between multivariate data in some examples.

Model-based approaches rely on an analytical model for each cluster where the objective is to find the best models to fit the observation sequences. Examples of analytical models include HMMs, as well as regression models, and autoregressive-moving-average (ARMA) models. For HMM models, a probabilistic model-based approach may be used for clustering sequences. In some examples, a pairwise distance matrix may be configured between observation sequences by computing a symmetrized similarity. This similarity may be obtained by training an HMM for each sequence, so that the log-likelihood of each sequence, given each model, can be computed. This information is then used to cluster the sequences into K groups using a hierarchical clustering algorithm.

After that, one HMM may be trained for each cluster, where the resulting K models are then merged into a composite global HMM. This initial estimate may further be refined using an expectation-maximization (EM) algorithm. As a result, a global HMM for modeling all the sequences may be obtained. In some examples, a model based HMM clustering problem may be addressed by searching for the best HMM topology and finding the most likely number of clusters. In some examples, a clustering result may be obtained using DTW as a similarity metric to provide an estimate of K and to yield an initial partitioning of the data. While model-based approaches provide a general probabilistic framework for clustering temporal sequences, initial conditions should be tailored to maintain the quality of clustering.

Turning back to FIG. 3B, clustering may be performed in block 318 utilizing any of the clustering algorithms 320, including k-medoids 322, which partition and break datasets into clusters 328 and minimize the distance between points labeled to be in a cluster and a point designated as the center (medoids or exemplars) of that cluster. K-medoids can be used with arbitrary dissimilarity measures (metrics), and because k-medoids minimize a sum of pairwise dissimilarities (instead of, e.g., a sum of squared Euclidean distances), it is more robust to noise and outliers.

Another clustering algorithm 320 includes agglomerative clustering 324 (also known as agglomerative nesting), which is a hierarchical clustering used to group datasets in clusters based on their similarity. Agglomerative clustering 324 starts by treating each object as a singleton cluster, and pairs of clusters are successively merged until all clusters have been merged into a single, larger, cluster containing all datasets or objects. The result is a tree-based representation of the objects (dendrogram). In some examples, agglomerative clustering may be configured in a “bottom-up” manner. That is, each dataset or object is initially considered as a single-element cluster (leaf). At each step of the algorithm, the two clusters that are the most similar are combined into a new bigger cluster (nodes). This procedure is iterated until all points are member of just one single big cluster (root). Distance between cluster may depends on a data type, domain knowledge etc., and to calculate distance cluster linkage 330 may be determined, based on single linkage (minimum distance between two points of different clusters), complete (maximum distance between each data point), average (average of distances between all pairs of data points) and/or centroid linkage (distance between centroid of clusters).

A further clustering algorithm 320 includes spectral clustering 326. Spectral clustering is an exploratory data analysis (EDA) technique that reduces complex multidimensional datasets into clusters of similar data in rarer dimensions. Generally, all spectrum of unorganized data points are clustered into multiple groups, based upon their uniqueness. Spectral Clustering 326 may be configured to use a connectivity approach to clustering, wherein communities of nodes (i.e., data points) that are connected or immediately next to each other are identified in a graph. The nodes are then mapped to a low-dimensional space that can be segregated to form clusters 332. Spectral Clustering uses information from the eigenvalues (spectrum) of special matrices (i.e., Affinity Matrix, Degree Matrix, Laplacian Matrix, etc.) derived from the graph or the data set. One skilled in the art will appreciate that other suitable clustering techniques are contemplated in the present disclosure and that the specific algorithms described in FIGS. 3A-B are illustrative, and not intended to be limiting. For example, any clustering algorithm that uses a distance matrix can be applied for the configurations disclosed herein.

The output from the initial clustering in 320 is then input to a second clustering process 336, in which HMMs (HMM 1-HMM k) are formed for each of the clusters from 320. Iterations of clustering from block 336 are then used to generate data 334 that is stored and, in some examples, fed back into block 335 as shown in the figure to maintain and update the clustering of vehicle as new data is added. Once the clusters in 336 are sufficiently trained, data from new vehicles 338 may be compared to the cluster data 336 to determine, for each new vehicle, if the vehicle data matches, within a predefined threshold, one or more of the clusters (HMM 1-HMM k) and this is associated 340 with the one or more clusters. Using this association, a SOH 342 for a vehicle battery may be forecasted.

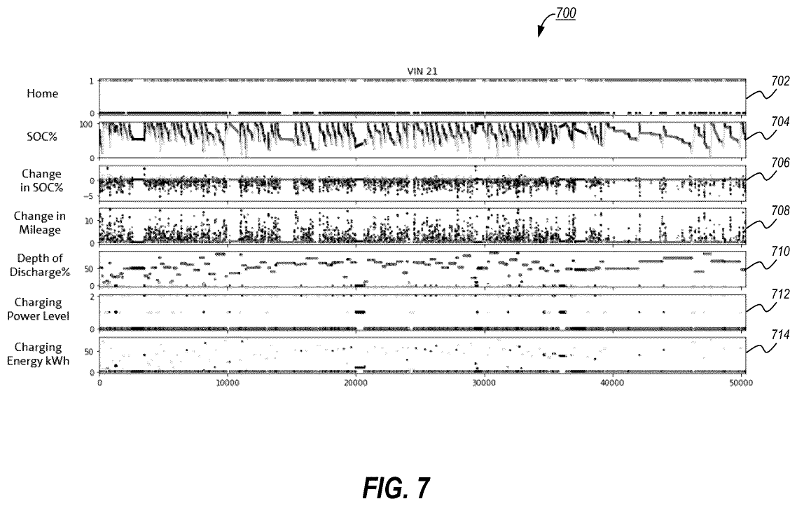

FIG. 7 shows an exemplary diagram 700 of hidden state sequences of raw multivariate time series according to some aspects of the present disclosure. The diagram 700 shows simulated measurements of the raw multivariate time series represented by the learned hidden states of the HMM. In this example, the fitted HMM automatically classifies segments of the time series into 1 of 3 hidden states. In general, the charging location is shown in 702, representing if a vehicle was charges at home or not. The SOC % is represented in 704, the change in mileage is represented in 708, the depth of discharge % is represented in 710, the charging power level is represented in 712, and the charging energy (kWh) is represented in 714. The data point may be configured to signify changes (e.g., increasing, decreasing, relative no change) in the data. Thus, for example, the data in 700 may be configured to indicate changes in discharge cycles (change in SOC % is positive/negative/zero), mileage is increasing/decreasing/zero, and depth of discharge is zero/nonzero, and charging power level/energy is zero/nonzero. Other configurations are also contemplated in the present disclosure, including levels or rates of change (e.g., low, medium, high), and/or idle states.

The technologies and techniques disclosed in FIGS. 3A-3B may be executed entirely within a server/cloud system (e.g., 216) communicatively coupled (e.g., via network 214) to one or more vehicles (e.g., 101), or may executed using a combination of processing functions shared between the server/cloud system and each vehicle. In one example, each vehicle 101 may simply transmit raw multivariate time series data (304) to the server/cloud, at which point the server/cloud performs the remaining processing steps to train (e.g., 304-336) the vehicle cluster data and process new vehicle data to determine a SOH forecast for the new vehicle/battery (338-342). In another example, some of the pre-processing steps (e.g., 304-312) are performed in the vehicle, and the remaining steps (314-342) are performed in the server/cloud. One skilled in the art will appreciate that numerous other configurations are contemplated in the present disclosure, and that the specific processing steps are not intended to be limiting.

It should be understood that SOH forecasting (342) has a multitude of technical application beyond data processing and analysis. For example, once a SOH forecast 342 is determined for a cluster, the server/cloud may transmit a control signal comprising control data (e.g., via network 214) to each of the vehicles belonging to the cluster, wherein the control signal includes executable information for the vehicle. The executable information may include diagnostic information, which, when executed by a processor (e.g., 107) of the vehicle, allows the vehicle to perform diagnostic functions in relation to the battery (e.g., via the BMS 105). The diagnostic function may be associated with monitoring one or more vehicle components as they relate to battery function, and/or monitor and/or alter the frequency of reporting the time series data (304) to the server/cloud. In some examples, the executable information may include vehicle battery management instructions, which, when executed by the vehicle's processor (e.g., 107) controls some aspect of battery management (e.g., via BM 105) by controlling operation of one or more vehicle circuits to perform functions that conserve and/or prolong battery life.

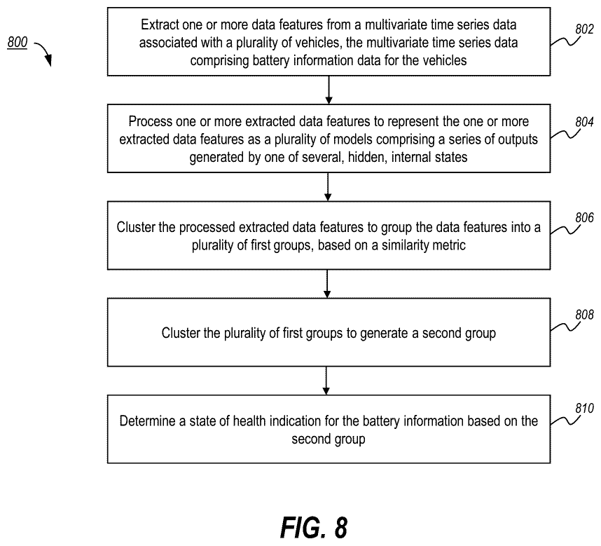

FIG. 8 shows a flowchart illustrating a process for processing a state of health for a battery under some aspects of the present disclosure. In block 802, one or more processors (e.g., server/cloud 216, and/or processor 107) extract one or more data features from a multivariate time series data associated with a plurality of vehicles (e.g., 302), the multivariate time series data comprising battery information data for the vehicles. In some examples, the multivariate time series data may include the raw data received from vehicles 302 and stored in block 304. One or more data features may be extracted utilizing feature engineering disclosed in 312 of FIG. 3A. In block 804, one or more processors may process one or more extracted data features to represent the one or more extracted data features as a plurality of models comprising a series of outputs generated by one of several, hidden, internal states. In some examples, the processing of one or more extracted data features to represent the one or more extracted data features as a plurality of models may be executed using the HMMs 314.

In block 806, one or more processor may cluster the processed extracted data features to group the data features into a plurality of first groups, based on a similarity metric. The processed extracted data may be clustered using any of clustering algorithms described in 318, 320 of FIG. 3B, and the similarity metric may be determined by distance matrix 316 of FIG. 3A. In block 808, the one or more processors may cluster the plurality of first groups to generate a second group. The clustering of the first groups to generate the second group refers to the HMM representation of clusters and may be performed by models 336 of FIG. 3B. In block 810, the one or more processors may determine a state of health indication (SOH forecasting) for the battery information based on the second group. The processes shown in 338-342 of FIG. 3B may be used to determine the state of health indication under some examples. In some examples, the second group provides a homogeneous grouping that can be used to improve SOH forecasting, where the SOH forecast may utilize different AI models.

As described above, some or all illustrated features may be omitted in a particular implementation within the scope of the present disclosure, and some illustrated features may not be required for implementation of all examples. In some examples, the methods and processes described herein may be performed by a vehicle (e.g., 101), as described above and/or by a processor/processing system or circuitry (e.g., 102-111) or by any suitable means for carrying out the described functions.

The following provides an overview of aspects of the present disclosure:

Aspect 1 is A battery management system for processing a state of health for a battery, comprising: at least one data storage configured to store computer program instructions; and at least one processor, operatively coupled to the at least one data storage, wherein the at least one processor is configured to: extract one or more data features from a multivariate time series data associated with a plurality of vehicles, the multivariate time series data comprising battery information data for the vehicles; process one or more extracted data features to represent the one or more extracted data features as a plurality of models comprising a series of outputs generated by one of several internal states; cluster the processed extracted data features to group the data features into a plurality of first groups, based on a similarity metric; cluster the plurality of first groups to generate a second group; and determine a state of health indication for the battery information based on the second group.

Aspect 2 may be combined with aspect 1 and includes that the extracted one or more data features comprise one or more of (i) vehicle charging location, (ii) state of battery charge. (iii) change in state of charge. (iv) depth of discharge. (v) change in vehicle mileage, (vi) battery charging power, (vii) charging energy, and/or (viii) temperature.

Aspect 3 may be combined with any of aspects 1 and/or 2, and includes that the at least one processor is configured to calculate distances between the plurality of models using mutual fitness, and to construct a distance matrix.

Aspect 4 may be combined with any of aspects 1 through 3, and includes that the distance matrix is used as an input to cluster the plurality of first groups to generate the second group.

Aspect 5 may be combined with any of aspects 1 through 4, and includes that the at least one processor is configured to cluster the plurality of first groups to generate the second group using one of k-medoids, agglomerative or spectral clustering.

Aspect 6 may be combined with any of aspects 1 through 5, and includes that the at least one processor is configured to cluster the plurality of first groups to generate the second group by training a Hidden Markov Model (HMM) for each of the plurality of first groups and merging a configured number of models into a composite global HMM.

Aspect 7 may be combined with any of aspects 1 through 6, and includes that the at least one processor is configured to generate a control signal based on the determined a state of health indication for controlling operation of a vehicle.

Aspect 8 is a computer-implemented method of processing a state of health for a battery in a battery management system, comprising: extracting one or more data features from a multivariate time series data associated with a plurality of vehicles, the multivariate time series data comprising battery information data for the vehicles; processing one or more extracted data features to represent the one or more extracted data features as a plurality of models comprising a series of outputs generated by one of several internal states; clustering the processed extracted data features to group the data features into a plurality of first groups, based on a similarity metric; clustering the plurality of first groups to generate a second group; and determining a state of health indication for the battery information based on the second group.

Aspect 9 may be combined with aspect 8 and includes that the extracted one or more data features comprise one or more of (i) vehicle charging location, (ii) state of battery charge. (iii) change in state of charge. (iv) depth of discharge. (v) change in vehicle mileage, (vi) battery charging power, (vii) charging energy, and/or (viii) temperature.

Aspect 10 may be combined with any of aspects 8 and/or 9, and includes calculating distances between the plurality of models using mutual fitness, and constructing a distance matrix.

Aspect 11 may be combined with any of aspects 8 through 10, and includes using the distance matrix as an input to cluster the plurality of first groups to generate the second group.

Aspect 12 may be combined with any of aspects 8 through 11, and includes that clustering the plurality of first groups to generate the second group comprises using one of k-medoids, agglomerative or spectral clustering.

Aspect 13 may be combined with any of aspects 8 through 12, and includes that clustering the plurality of first groups to generate the second group comprises training a Hidden Markov Model (HMM) for each of the plurality of first groups and merging a configured number of models into a composite global HMM.

Aspect 14 may be combined with any of aspects 8 through 13, and includes generating a control signal based on the determined state of health indication for controlling operation of a vehicle.

Aspect 15 is a non-transitory computer-readable medium storing executable instructions for processing a state of health for a battery for a battery management system, when executed by one or more processors, causes one or more processors to: extract one or more data features from a multivariate time series data associated with a plurality of vehicles, the multivariate time series data comprising battery information data for the vehicles; process one or more extracted data features to represent the one or more extracted data features as a plurality of models comprising a series of outputs generated by one of several internal states; cluster the processed extracted data features to group the data features into a plurality of first groups, based on a similarity metric; cluster the plurality of first groups to generate a second group; and determine a state of health indication for the battery information based on the second group.

Aspect 16 may be combined with aspect 15 and further includes that the extracted one or more data features comprise one or more of (i) vehicle charging location, (ii) state of battery charge. (iii) change in state of charge. (iv) depth of discharge. (v) change in vehicle mileage, (vi) battery charging power, (vii) charging energy, and/or (viii) temperature.

Aspect 17 may be combined with any of aspects 15 and/or 16, and includes that the executable instructions for processing a state of health for a battery, when executed by one or more processors, causes one or more processors to: calculate distances between the plurality of models using mutual fitness, and constructing a distance matrix.

Aspect 18 may be combined with any of aspects 15 through 17, and includes that the executable instructions for processing a state of health for a battery, when executed by one or more processors, causes one or more processors to: use the distance matrix as an input to cluster the plurality of first groups to generate the second group.

Aspect 19 may be combined with any of aspects 15 through 18, and includes that the plurality of first groups to generate the second group comprises using one of k-medoids, agglomerative or spectral clustering.

Aspect 20 may be combined with any of aspects 15 through 19, and includes that clustering the plurality of first groups to generate the second group comprises training a Hidden Markov Model (HMM) for each of the plurality of first groups and merging a configured number of models into a composite global HMM.

In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A battery management system for processing a state of health for a battery, comprising:
at least one data storage configured to store computer program instructions; and
at least one processor, operatively coupled to the at least one data storage, wherein the at least one processor is configured to:
extract one or more data features from a multivariate time series data associated with a plurality of vehicles, the multivariate time series data comprising battery information data for the vehicles;
process one or more extracted data features to represent the one or more extracted data features as a plurality of models comprising a series of outputs generated by one of several internal states;
cluster the processed extracted data features to group the data features into a plurality of first groups, based on a similarity metric;
cluster the plurality of first groups to generate a second group; and
determine a state of health indication for the battery information based on the second group.

2. The system of claim 1, wherein the extracted one or more data features comprise one or more of (i) vehicle charging location, (ii) state of battery charge, (iii) change in state of charge, (iv) depth of discharge, (v) change in vehicle mileage, (vi) battery charging power, (vii) charging energy, and/or (viii) temperature.

3. The system of claim 1, wherein the at least one processor is configured to calculate distances between the plurality of models using mutual fitness, and to construct a distance matrix.

4. The system of claim 3, wherein the distance matrix is used as an input to cluster the plurality of first groups to generate the second group.

5. The system of claim 1, wherein the at least one processor is configured to cluster the plurality of first groups to generate the second group using one of k-medoids, agglomerative or spectral clustering.

6. The system of claim 5, wherein the at least one processor is configured to cluster the plurality of first groups to generate the second group by training a Hidden Markov Model (HMM) for each of the plurality of first groups and merging a configured number of models into a composite global HMM.

7. The system of claim 1, wherein the at least one processor is configured to generate a control signal based on the determined a state of health indication for controlling operation of a vehicle.

8. A computer-implemented method of processing a state of health for a battery in a battery management system, comprising:
extracting one or more data features from a multivariate time series data associated with a plurality of vehicles, the multivariate time series data comprising battery information data for the vehicles;
processing one or more extracted data features to represent the one or more extracted data features as a plurality of models comprising a series of outputs generated by one of several internal states;
clustering the processed extracted data features to group the data features into a plurality of first groups, based on a similarity metric;
clustering the plurality of first groups to generate a second group; and
determining a state of health indication for the battery information based on the second group.

9. The computer-implemented method of claim 8, wherein the extracted one or more data features comprise one or more of (i) vehicle charging location, (ii) state of battery charge, (iii) change in state of charge, (iv) depth of discharge, (v) change in vehicle mileage, (vi) battery charging power, (vii) charging energy, and/or (viii) temperature.

10. The computer-implemented method of claim 8, further comprising calculating distances between the plurality of models using mutual fitness, and constructing a distance matrix.

11. The computer-implemented method of claim 10, further comprising using the distance matrix as an input to cluster the plurality of first groups to generate the second group.

12. The computer-implemented method of claim 8, wherein clustering the plurality of first groups to generate the second group comprises using one of k-medoids, agglomerative or spectral clustering.

13. The computer-implemented method of claim 12, wherein clustering the plurality of first groups to generate the second group comprises training a Hidden Markov Model (HMM) for each of the plurality of first groups and merging a configured number of models into a composite global HMM

14. The computer-implemented method of claim 8, further comprising generating a control signal based on the determined state of health indication for controlling operation of a vehicle.

15. A non-transitory computer-readable medium storing executable instructions for processing a state of health for a battery for a battery management system, when executed by one or more processors, causes one or more processors to:
extract one or more data features from a multivariate time series data associated with a plurality of vehicles, the multivariate time series data comprising battery information data for the vehicles;
process one or more extracted data features to represent the one or more extracted data features as a plurality of models comprising a series of outputs generated by one of several internal states;
cluster the processed extracted data features to group the data features into a plurality of first groups, based on a similarity metric;
cluster the plurality of first groups to generate a second group; and
determine a state of health indication for the battery information based on the second group.

16. The non-transitory computer-readable medium of claim 15, wherein the extracted one or more data features comprise one or more of (i) vehicle charging location, (ii) state of battery charge, (iii) change in state of charge, (iv) depth of discharge, (v) change in vehicle mileage, (vi) battery charging power, (vii) charging energy, and/or (viii) temperature.

17. The non-transitory computer-readable medium of claim 15, wherein the executable instructions for processing a state of health for a battery, when executed by one or more processors, causes one or more processors to:
calculate distances between the plurality of models using mutual fitness, and constructing a distance matrix.

18. The non-transitory computer-readable medium of claim 17, wherein the executable instructions for processing a state of health for a battery, when executed by one or more processors, causes one or more processors to:
use the distance matrix as an input to cluster the plurality of first groups to generate the second group.

19. The non-transitory computer-readable medium of claim 15, wherein clustering the plurality of first groups to generate the second group comprises using one of k-medoids, agglomerative or spectral clustering.

20. The non-transitory computer-readable medium of claim 19, wherein clustering the plurality of first groups to generate the second group comprises training a Hidden Markov Model (HMM) for each of the plurality of first groups and merging a configured number of models into a composite global HMM
